(19) United States
(12) Patent Application Publication
(10) Pub. No.: US 2023/0122795 A1
(43) Pub. Date: Apr. 20, 2023

(54) THREADED CONNECTION TO CARRIER FOR HYDRAULIC CONNECTION TO A CASE WITH AN EXTERNALLY MOUNTED PLENUM TUBE

(71) Applicant: Eaton Intelligent Power Limited, Dublin (IE)

(72) Inventors: Chad Hillman, Ceresco, MI (US); Mark Shewchuck, Charlotte, MI (US)

(21) Appl. No.: 17/910,882

(22) PCT Filed: Mar. 10, 2021
(86) PCT No.: PCT/EP2021/025100

§ 371 Date: Sep. 12, 2022

Related U.S. Application Data
(60) Provisional application No. 62/987,492, filed on Mar. 10, 2020.

(51) Int. Cl. F15B 15/20; F16L 5/06

(52) U.S. Cl. CPC F15B 15/20; F16L 5/06

(57) ABSTRACT

A carrier can comprise a through-port in a carrier plate. A threaded connection can comprise a threaded cap comprising a tubular body, a central port through the tubular body, and a rim clenching a face seal to the carrier plate when a nut is tightened to the threaded cap. A plenum in a case can be installed in the carrier. The case can comprise a case portion seating a piston and forming the plenum. The piston can be configured to actuate in the plenum in a first axial direction upon supply of hydraulic fluid to the plenum. A plenum port can extend from the case portion. The plenum port can be configured to communicate hydraulic fluid to the plenum to actuate the piston. The central port of the threaded connection can comprise a hydraulic tube mounted directly or indirectly to the plenum port to supply the hydraulic fluid.

### FIELD

This application provides a carrier with a threaded connection. The carrier can house a plenum in a case, and the threaded connection can be used to align a hydraulic tube with a plenum port extending from the case. Such a threaded connection can be used with a limited slip differential with an externally mounted plenum tube.

### BACKGROUND

A case can be bulky when hydraulic control is mounted thereto. A carrier surrounding the case can be enlarged to accommodate the hydraulic control. Or, the carrier can seat the hydraulic control, but this can also enlarge the carrier. In either instance, there is weight and bulk placed at the carrier. When employed on a differential, the hydraulic control on the carrier or case places bulk and weight close to the axles located in the differential. However, it is desired to keep this area free of bulk and it is desired not to strain the axles unnecessarily.

One example of a differential gear mechanism is set forth in U.S. Pat. No. 9,915,333. Modifications to this and other differential gear mechanisms are compatible with the teachings herein.

### SUMMARY

The methods and devices disclosed herein overcome the above disadvantages and improves the art by way of remote-mounting hydraulic control from a carrier and case. Improved connections are needed to port the remote-mounted hydraulic control to the carrier and case.

A carrier can comprise a through-port in a carrier plate. A threaded connection can comprise a rim clenching a face seal to the carrier plate of the carrier when a nut is tightened to a threaded second half of a threaded cap. A plenum in a case can be installed in the carrier. The case can comprise a case portion seating a piston and forming the plenum. The piston can be configured to actuate in the plenum in a first axial direction upon supply of hydraulic fluid to the plenum. A plenum port can extend from the case portion. The plenum port can be configured to communicate hydraulic fluid to the plenum to actuate the piston. The threaded connection can comprise a hydraulic tube in the central port. The hydraulic tube can be mounted directly or indirectly to the plenum port and can be configured to supply the hydraulic fluid.

A threaded connection for a plenum can comprise a threaded cap comprising a tubular body, a central port through the tubular body, and a rim dividing the tubular body between a first half and a threaded second half. A face seal can seat against the rim. A nut can be configured to seat on the threaded second half. A hydraulic tube can be seated in the central port.

Additional objects and advantages will be set forth in part in the description which follows, and in part will be obvious from the description, or may be learned by practice of the disclosure. The objects and advantages will also be realized and attained by means of the elements and combinations particularly pointed out in the appended claims.

### BRIEF DESCRIPTION OF THE DRAWINGS

FIG. 1 is a cross-section view of a carrier surrounding a case.

FIGS. 2A & 2B are examples of threaded connections showing alternative direct and indirect connections to plenum ports.

FIG. 3 is view of the case, plenum port, and threaded connection.

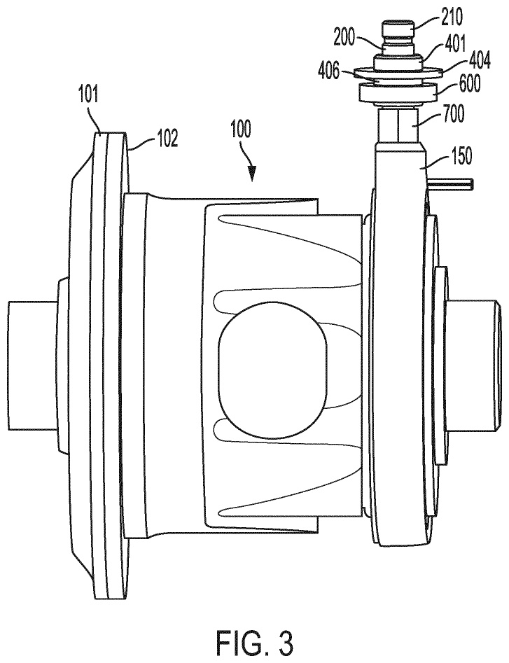

### DETAILED DESCRIPTION

Reference will now be made in detail to the examples which are illustrated in the accompanying drawings.

A threaded connection 2, 3 for a plenum 110 is shown and described. A plenum 110 is a chamber where a fluid can collect. Pressurizing the fluid in the plenum 110 can cause control of one or more downstream device.

In the working example described herein, a piston 109 is seated relative to the plenum 110 so that pressurized fluid can actuate the piston 109. The piston 109 can be moved by the pressurized fluid. Relief of the fluid pressure and an opposing force, such as a return spring force, can return the piston to a starting position. A return spring force can be applied, for example, by a return spring or by a tendency of a downstream device to spring apart. Such a tendency to spring apart happens in the illustrated example when a clutch pack 60 exerts compliance to expand.

A carrier 1 can enclose a device. The carrier 1 can form a dust cover or fluid compartment. An eLSD (electronically-controlled limited slip differential) is an example of a device that benefits from the threaded connection 2, 3. The eLSD can be installed in a solid axle application with a remote mount hydraulic control unit (HCU) to supply hydraulic pressure to a piston 82 that provides force to a clutch pack 60. Electronics can control the HCU. Hydraulic control unit can be remote mounted with a hydraulic line that can transfer the hydraulic fluid between the HCU and the differential/plenum. A supply hose or tubing or the like can couple to a hydraulic tube 200 in the threaded connection 2, 3.

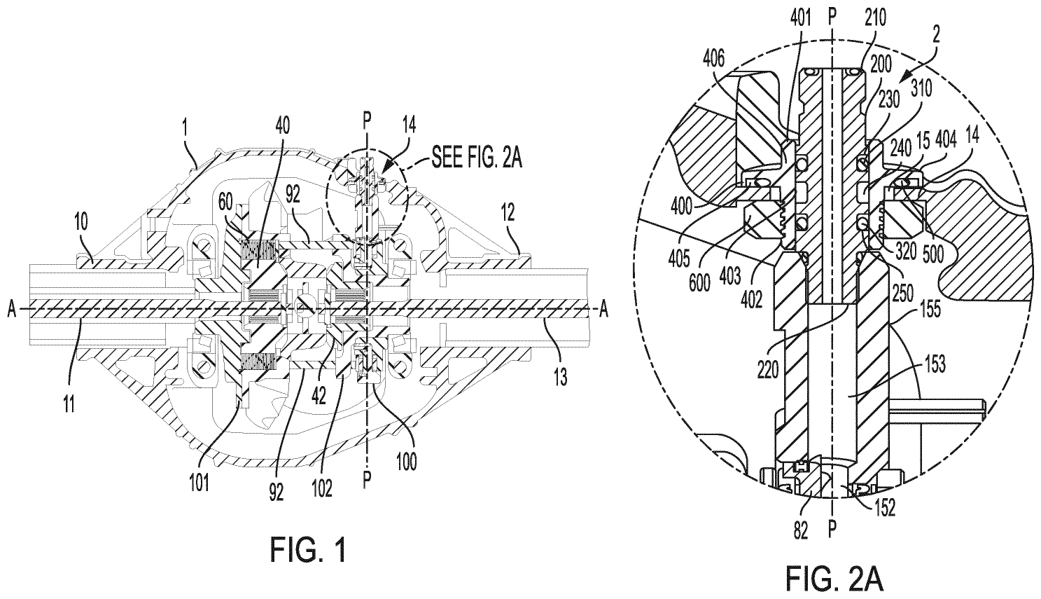

The differential can comprise side gears 40, 42 coupled to axles 11, 13. Pinion gears 52 can be included, as can a reaction block 53. Comparing FIGS. 1 & 2, the differential can be rotated relative to the plenum port 155 so that its bulk is either aligned with the transfer rods 92 or offset from the transfer rods 92. Carrier 1 can comprise openings 10, 12 for the axles 11, 13 to pass through. The differential can be used to provide a variable bias torque as required to allow mobility in split mu applications. It can also be used to help mitigate trailer sway in event that the end user is towing a trailer.

The eLSD differential can be mounted inside of a carrier 1. A carriage, chassis, or frame, remote from the carrier 1, can be used to mount the hydraulic control unit. The differential can comprise a hydraulic actuator mounted to interface with the plenum 110. Hydraulic actuator can comprise the piston 82 configured with a bearing and reaction plate to press transfer rods 92 into a transfer plate. The clutch pack 60 can be configured with a transfer plate to receive actuation force from the transfer rods and to distribute clutch pack compliance back towards the piston 82.

In the example application, the differential is mounted in a solid axle application. An entrance hole, through-hole 15 in carrier plate 14, is through the top of the carrier 1. Carrier plate 14 can be a stamped, cast, molded, or otherwise formed area yielding an inner and outer surface for seating the threaded connection 2, 3. Through-hole 15 can be punched, cast, molded or otherwise formed in the carrier plate 14. By using the threaded connection 2, 3 herein, the tolerance for the through-hole 15 can be relaxed. The large carrier 1 is less prone to being scrapped, resulting in material conservation.

The hydraulic control unit is remote mounted in another location with a hydraulic line connecting the HCU to the plenum 110 to allow for transfer of the hydraulic fluid between the two units. The remote location can be a chassis or carriage portion of a vehicle or motive device. The system can incorporate pressure and temperature sensors to measure pressure and temperature at the clutch pack 60 and at an accumulator of the HCU. The vehicle or motive device can also be incorporated with vehicle controls to sense wheel slip and send hydraulic pressure to the plenum 110 to adjust the bias torque at the clutch pack 60 as required by the motive device or vehicle.

Instead of a large HCU mounted on the differential, it is remote-mounted. The footprint of the new fitting and piston/plenum saves space in the axle area and transfers the large package of the HCU to the remote location.

When the Hydraulic Control Unit (HCU) is direct-mounted, then there are no considerations for accommodating a threaded connector 2, 3. The differential can be configured differently in the hydraulic actuation area than when a threaded connection 2, 3 must be accommodated. For example, an encapsulation volume can be integrated within the carrier 1, and possibly to the case 100 of the differential, when the HCU is direct-mounted. This can impact the symmetry and size of the carrier 1 or the bulk of the case 100. The case 100 or axles 11, 13 could be bulky to support the encapsulation for the HCU. The carrier 1 could be large to surround the HCU. Both of these place weight and bulk at the axles 11, 13 connected at the differential. However, the threaded connector 2, 3 permits a smaller case 100 and smaller carrier 1, conveying less weight at the differential.

The case 100 can comprise a cover portion 101 and housing portion 102 to enclose portions of the differential. A piston 82 and plenum 110 can be included in a case portion 150. The case 100 can be formed by fastening the cover portion 101, housing portion 102, and case portion 150 together. Alternative differentials integrate aspects of the case portion 150 with the housing portion 102 so that the plenum 110 is molded or cast into the housing portion 102.

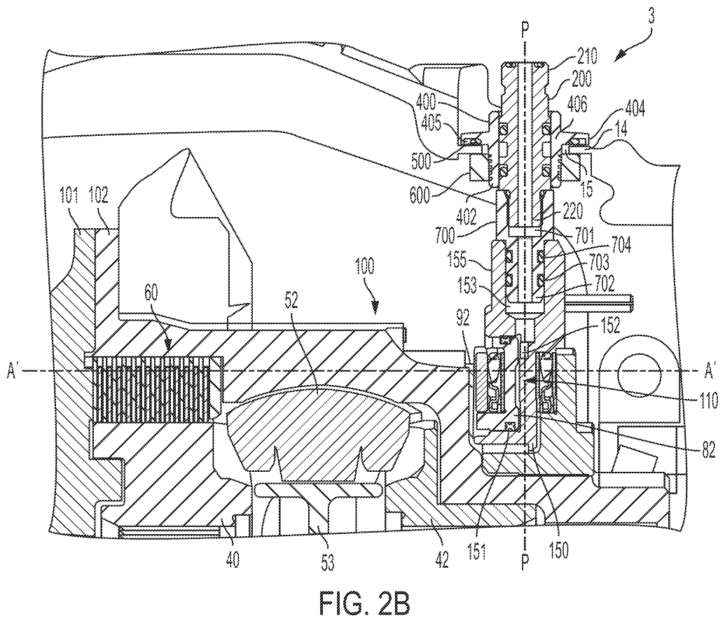

In FIG. 2A, the hydraulic tube 200 directly couples to plenum port 155, but in FIG. 2B, an intermediary coupling can be included in the form of extension piece 700. Extension piece 700 couples a receiving end 701 to the hydraulic tube 200 and couples a slip fitted plug end 702 within the plenum port 155. O-rings in glands 703, 704 can be included on the plug end 702. The extension piece 700 can step-down and comprise two outer diameters of different size. The plug end 702 outer diameter can be smaller than the outer diameter of the receiving end 701. The hydraulic tube 200 can also step-down in its outer diameter relative to the plenum port 155. Hydraulic tube 200 can also step-down its outer diameter relative to the receiving end 701. It can be said that the hydraulic connection assembly radially steps down along the port axis P-P (second axis) from plenum 110 to connector end 210 of the hydraulic tube 200. Because the hydraulic connection assembly steps down radially, the modification area to the case to accommodate the hydraulic connection can be made small and the profile of the carrier 1 can be kept small. Packaging benefits and lower material use benefits are achieved.

Also, a small diameter supply hose can be used at the connector end 210. A high pressure of the hydraulic fluid is achieved. A “quick connect” coupling on the supply hose can couple to the grooves included on connector end 210. Alternatives such as threaded connections, snap fitted connections, or press-fit arrangements such as stepped nozzles could alternatively be used on the connector end 210.

In lieu of a large pump package on the case 100 or in or on the carrier 1, the plenum tube 155 is external to the case 100. Plenum tube 155 can be integrally formed with the case 100, and it can jut away from the case 100. The plenum tube 155 has a small volume and low volumes of hydraulic fluid are needed. The case portion 150 housing piston 82 and plenum 110 is also a low profile arrangement with the plenum 110 accumulating a minimal amount of hydraulic fluid.

A threaded connection 2, 3 to a differential housing, in this instance, case portion 150, is shown with a small footprint. Threaded connection 2, 3 to a plenum 110 can comprise a threaded cap 400, a face seal 500, and a nut 600 configured to provide good sealing and positioning of a hydraulic tube 200 with respect to a plenum port 155.

Threaded connection 2, 3 for a plenum 110 can comprise a threaded cap 400. A tubular body 406, a central port 403 through the tubular body 406, and a rim 404 dividing the tubular body 406 between a first half 401 and a threaded second half 402. First half 401 can comprise at least the rim 404 extending radially from the tubular body 406. First half can optionally comprise a lip projecting away from the rim 404. The second half 402 can extend away from the rim 404 and can comprise external threading. Rim can comprise an annular receptacle 405 to wholly or partially receive a face seal 500. Face seal 500 can seat in the annular receptacle 405. Annular receptacle 405 can constitute a gland for an o-ring. The face seal 500 can constitute an o-ring and can comprise a sub-type of o-ring that is disc-like, flat, or planar and could constitute a stepped or ridged planar o-ring. Face seal 500 can prevent cross-contamination of carrier fluid and external fluids, such as any fluid leaking from hose at connection end 210. Hydraulic connection assembly prevents fluid mixing of hydraulic actuation fluid and any fluid in carrier 1.

Nut 600 can be configured to seat on the threaded second half 402. Nut 600 can comprise internal threading to thread to the second half 402. Nut 600 can be on an interior side of carrier plate 14 while face seal 500 and rim 404 can be on an exterior side of carrier plate 14. Nut 600 can pull rim 404 and face seal 500 tight against the exterior side of carrier plate 14 when a surface of nut 600 contacts the interior side of carrier plate 14.

A diameter of the rim 404, face seal 500, and nut 600 can be kept large, while the outer diameter of tubular body 406 is kept small. Tubular body 406 can easily fit in through-hole 15 when its diameter is kept small relative to the through-hole 15. This option can allow elimination of a roughing-out step of the through-hole when the inner diameter of the through-hole 15 is closely matched to that of a supply hose, connector, or other arrangement, or when the inner diameter of the through-hole 15 is closely matched to the outer diameter of the tubular body 406. Instead of manually rasping the through-hole 15 to maintain a closely sized relationship, the through-hole 15 can be large enough to result in a gap between all or most of the tubular body 406. So, an arc or portion of the tubular body 406 can abut the through-hole 406 when the threaded connection 2, 3 is located relative to the plenum port 155, or the tubular body 406 can be centered in the through-hole 15, or the tubular body 406 can more loosely float non-centered in the through-hole 15. The tightening of the nut 600 against the carrier plate 14 causes rim 404 to clench the face seal 500 to the carrier plate 14. Carrier 1 can include outer boundaries, such as steps, ledges, rims or the like as travel limits or supports for the nut 600 and rim 404.

Hydraulic tube 200 can be seated in the central port 403. Now, it is easier to cope if a supplier changes supply hose type or connector to the supply hose. Hydraulic tube 200 can be swapped for a compatible connector type instead of scrapping the whole threaded connector 2, 3. And, production is more easily continued in the face of unavailability of certain connector or supply hose types. Also, the plenum port 155 can be kept a generic shape instead of a specialized connector shape. The hydraulic tube 200 can be changed instead of scrapping the plenum port 155 to accommodate a buyer connection demand.

Hydraulic tube 200 can be slip fit in the central port 403 with o-rings 310, 320. An upper gland 230 can seat a first o-ring 310, a lower gland 250 can seat a second o-ring 320, and a vacant gland 240 can be between the upper gland 230 and the lower gland 250. Vacant gland 240 can permit light weighting or limited flex of the hydraulic tube 200.

Hydraulic tube 200 comprises a plug end 220 and a connector end 210. Connector end 210 can be configured to couple to a supply hose. Plug end 200 can seat directly in the plenum port 155 or indirectly in the plenum port 155 as via extension piece 700. Plenum port 155 can comprise an inner passageway 153 that can be stepped to receive the plug end 220 via press fit. A chamfer at an end of the plenum port 155 can facilitate assembly. Inner passageway can be stepped down to an interface area 152 with plenum 110. Interface area 152 can terminate the hydraulic connection assembly to the plenum 110. Case portion 150 can be somewhat “L” shaped to accommodate an orthogonal axis arrangement of port axis P-P to parallel axis A′-A′. A receptacle 151 can be formed in case portion 150 to receive the piston 82 and to form the plenum 110. Piston 82 can be sealed by o-rings to the receptacle 151 to prevent unwanted leakage or to provide wiper lubrication.

A carrier 1 can comprise a through-port 15 in a carrier plate 14. A threaded connection 2, 3 can comprise a rim 404 clenching a face seal 500 to the carrier plate 14 of the carrier 1 when a nut 600 is tightened to a threaded second half 402 of a threaded cap 400. A plenum 110 in a case 100 can be installed in the carrier 1. The case 100 can comprise a case portion 150 seating a piston 82 and forming the plenum 150. The piston 82 can be configured to actuate in the plenum 110 in a first axial direction upon supply of hydraulic fluid to the plenum 110. First axial direction can be along a main axis A-A of the device, as the piston in this instance is annular in the case 100. Or, first axial direction can be parallel to the main axis A-A in the form of parallel axis A′-A′. As the piston 82 moves transfer rods 92 parallel to the main axis A-A in the example, it can be convenient to refer to the parallel axis A′-A′ as the source of the second axial direction. A plenum port 155 can extend from the case portion 150. The plenum port 155 can be configured to communicate hydraulic fluid to the plenum 110 to actuate the piston 82. The threaded connection 2, 3 can comprise a hydraulic tube 200 in the central port 403. The hydraulic tube 200 can be mounted directly or indirectly to the plenum port 155 and can be configured to supply the hydraulic fluid.

The plenum port 155 can be configured in a second axial direction orthogonal to the first axial direction. That is, a port axis P-P can be perpendicular to the main axis A-A or parallel axis A′-A′ so that actuation fluid, such as hydraulic fluid, travels to the plenum 110 in the second axial direction, yet moves the piston 82 in the first axial direction. So, the threaded connection 2,3 can be arranged in an orthogonal axial direction relative to the actuation direction of the piston 82. This yields packaging benefits. The footprint of the device is made small and the plenum 110 is made small. The small plenum 110 yields fast control and low fluid use.

The plenum port 155 can be integrally molded with the case portion 150. And, the threaded connection 2, 3 is configured to provide sealing and positioning of hydraulic tube 200 with respect to the plenum port 155. Hydraulic tube 200 comprises a plug end 220 and a connector end 210. Connector end 210 can be configured to couple outside the carrier 1 while plug end 220 can be configured to seat directly or indirectly in the plenum port 155. That is, hydraulic connection assembly can further comprise an extension piece 700 between the plug end 220 and plenum port 155. Extension piece 700 can be slip fit in the plenum port 155 and can be configured with o-rings to seal against the plenum port 155. Plug end can be press fit into the extension piece 700 without o-rings.

The hydraulic tube 200 can be slip fit in the central port 403 with o-rings 310, 320. The threaded cap 400 can be configured in the through-port 15 to align the hydraulic tube 200 with the plenum port 155. The hydraulic tube 200 can be slip fit with o-rings inside the threaded cap 400 for precise alignment with the plenum port 155. The threaded cap 400 can comprise a rim 404 that clenches face seal 500 to a carrier plate 14 of the carrier when the nut 600 is tightened to threads of the threaded cap 400.

A plenum 110 for a differential can comprise a piston 82 configured to actuate in the plenum 110 in a first axial direction (main axis A-A or parallel axis A′-A′) upon supply of hydraulic fluid. A plenum port 155 for communicating hydraulic fluid to the plenum 110 to actuate the piston 82 can be formed in a case portion 150 integrally molded with the plenum 110 and plenum port 155. Threaded connection 2, 3 can be mounted to the plenum port 155 and can be configured to supply hydraulic fluid in an axial direction (port axis P-P) orthogonal to the first axial direction.

The combination of the threaded cap 400, face seal 500, and nut 600 allows the through-hole 15 punched into the carrier 1 to be “sloppy” or low tolerance yet provide good sealing and positioning of the hydraulic tube 200 with respect to the plenum port 155. Hydraulic tube 200 can be slip fit with o-rings 310, 320 inside threaded cap 400 for precise alignment with the plenum port 155. Rim 404 of threaded cap 400 clenches face seal 500 to carrier 1 when nut 600 is tightened to the threads of tubular body 406.

Other implementations will be apparent to those skilled in the art from consideration of the specification and practice of the examples disclosed herein.

1. A threaded connection for a plenum, comprising:
a threaded cap comprising a tubular body, a central port through the tubular body, and a rim dividing the tubular body between a first half and a threaded second half;
a face seal; and
a nut configured to seat on the threaded second half.

2. The threaded connection of claim 1, further comprising a hydraulic tube in the central port.

3. The threaded connection of claim 2, further comprising the hydraulic tube slip fit in the central port with o-rings.

4. The threaded connection of claim 2, wherein the hydraulic tube comprises an upper gland seating a first o-ring, a lower gland seating a second o-ring, and a vacant gland between the upper gland and the lower gland.

5. The threaded connection of claim 1, wherein the rim comprises an annular receptacle, and wherein the face seal seats in the annular receptacle.

6. The threaded connection of claim 1, wherein the hydraulic tube comprises a plug end and a connector end, and wherein the connector end is configured to couple to a supply hose.

7. A carrier comprising a through-port in a carrier plate and the threaded connection of claim 1, wherein the rim clenches the face seal to the carrier plate of the carrier when the nut is tightened to the threaded second half.

8. A plenum in a case, the case installed in the carrier of claim 7, the case comprising:
a case portion seating a piston and forming the plenum, the piston configured to actuate in the plenum in a first axial direction upon supply of hydraulic fluid to the plenum;
a plenum port extending from the case portion, the plenum port configured to communicate hydraulic fluid to the plenum to actuate the piston; and
the threaded connection comprising a hydraulic tube in the central port, the hydraulic tube mounted directly or indirectly to the plenum port and configured to supply the hydraulic fluid.

9. The plenum in a case of claim 8, wherein the plenum port is configured in a second axial direction orthogonal to the first axial direction.

10. The plenum in a case of claim 8, wherein the plenum port is integrally molded with the case portion.

11. The plenum in a case of claim 8, wherein the threaded connection is configured to provide sealing and positioning of the hydraulic tube with respect to the plenum port.

12. The plenum in a case of claim 11, wherein the hydraulic tube comprises a plug end and a connector end, wherein the connector end is configured to couple outside the carrier, and wherein the plug end is configured to seat directly or indirectly in the plenum port.

13. The plenum in a case of claim 12, further comprising an extension piece between the plug end and plenum port.

14. The plenum in a case of claim 13, wherein the extension piece is slip fit in the plenum port and is configured with o-rings to seal against the plenum port, and wherein the plug end is press fit into the extension piece without o-rings.

15. The plenum in a case of claim 8, comprising the hydraulic tube slip fit in the central port with o-rings, the threaded cap configured in the through-port to align the hydraulic tube with the plenum port.
